(19) United States
(12) Patent Application Publication
(10) Pub. No.: US 2005/0145820 A1
(43) Pub. Date: Jul. 7, 2005

(54) Compositions and methods useful for synergistic combustion suppression

(76) Inventors: Stephanie D. Waldrop, Albuquerque, NM (US); Edward T. McCullough, Albuquerque, NM (US); Patrick M. Dhooge, Corrales, NM (US); Jonathan S. Nimitz, Albuquerque, NM (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/752,291

(22) Filed: Jan. 6, 2004

(51) Int. Cl. A62D 1/00

(52) U.S. Cl. 252/3

(57) ABSTRACT

Certain compositions comprising trifluoroiodomethane with physically-acting combustion suppressants, wherein the compositions exhibit strong synergistic combustion suppression and are useful for suppressing the combustion of many fuels. The compositions are thermally stable, compatible, non-ozone-depleting, low global warming, have reduced toxicity compared to pure trifluoroiodomethane, can be effective in lower weights and volumes than most other agents, and can be more cost-effective than current combustion suppressants.

### FEDERALLY SPONSORED RESEARCH

The U.S. Government has a paid-up license in this invention and the right in limited circumstances to require the patent owner to license others on reasonable terms as provided for by the terms of Medical Research Acquisition Activity Cooperative Agreement #DAMD17-972-7016 and National Medical Technology Testbed Sub-agreement #2000-82-Nimitz awarded by the U.S. Army.

### TECHNICAL FIELD

The present invention relates generally to a composition and method for combustion suppression, and more particularly to synergistic combustion suppressant compositions comprising trifluoroiodomethane combined with certain physically acting combustion suppressants, and methods of making and using such compositions.

### BACKGROUND OF THE INVENTION

Highly effective combustion suppressants are utilized for many fire protection applications, including total flooding applications wherein the fire suppressant is introduced into a room or other enclosed area to prevent or quench a fire. It is understood that included within the general term “combustion suppression” are the closely-related phenomena of fire suppression, explosion suppression, and inertion to prevent fire or explosion. In many applications, the combustion suppressant must be “clean”; that is, it must not leave any appreciable residue, and, as such, is typically a gas or low-boiling liquid that can be subsequently removed from the area with air flushing.

Highly effective combustion suppressants are also useful for adding to flammable compounds to prepare blends that are nonflammable but still retain many of the desirable properties of the flammable compounds. Such blends include solvents, sterilants, foam blowing agents, and refrigerants.

Bromofluorocarbon compounds (halons) such as bromotrifluoromethane (Halon 1301) have been used extensively as highly effective combustion suppressants, because they are stable, inexpensive, and compatible with most common materials. Historically, Halon 1301 was used as the primary clean, total flooding fire protection agent. Moreover, Halon 1301 was very low in toxicity, and humans can be safely exposed to the concentration necessary to suppress combustion. Halons were utilized from the 1950s into the 1990s. However, bromofluorocarbons in general have been implicated in stratospheric ozone depletion and, as such, production of same has been halted worldwide under the provisions of the Montreal Protocol because of their very high ozone depletion potential (ODP).

In many applications the trend has been to replace ozone-depleting halons, chlorofluorocarbons (CFCs), and hydrochlorofluorocarbons (HCFCs) with hydrofluorocarbons (HFCs). HFCs do not deplete stratospheric ozone, are generally low in toxicity, and are compatible with most materials. HFCs with high fluorine content are reasonably good combustion suppressants, but do have fairly high global warming potentials (GWPs). Heptafluoropropane, in particular 2H-heptafluoropropane, and pentafluoroethane are primary replacements for Halon 1301 as clean, total flooding fire protection agents. Unfortunately, both 2H-heptafluoropropane and pentafluoroethane are considerably more expensive per pound than Halon 1301, and require installation of new fire protection systems, because greater weights and volumes of same are required for combustion suppression in comparison to Halon 1301.

Another replacement for Halon 1301 is trifluoroiodomethane. Trifluoroiodomethane is about as effective as Halon 1301, thermally stable, compatible with most materials, with essentially zero ODP and very low GWP. Trifluoroiodomethane possesses desirable low atmospheric impact because it is sensitive to ultraviolet light and photolyzes in the atmosphere within about two days, forming the harmless natural products carbon dioxide, fluoride ion, and iodide ion. Thus, trifluoroiodomethane does not survive long enough in the atmosphere to have any significant atmospheric impact. However, two major disadvantages of trifluoroiodomethane are that its price is somewhat high and it has a fairly low cardiac sensitization level. More specifically, many halogenated and aliphatic compounds sensitize animal hearts to adrenaline. For instance, the well known refrigerant R-12 (CFC-12) is also a cardiac sensitizing compound. The Beagle dog cardiac sensitization Lowest Observable Adverse Effects Level (LOAEL) for trifluoroiodomethane is about 0.4 volume percent in air. Thus, at its effective combustion suppression level of about 3 volume percent in air, it is about a factor of 7.5 times above the maximum safe exposure level as presently defined by the U.S. EPA. As such, the U.S. EPA approves the use of trifluoroiodomethane as a total flooding fire protection agent only for normally unoccupied areas.

In addition to utilization in fire protection, combustion suppressants can be added to flammable compounds or mixtures of compounds to form blends that are nonflammable. For example, the inventors of the present combustion suppressant found that the flammable refrigerant compound 1,1-difluoroethane can be blended with trifluoroiodomethane to make a nonflammable composition that retains much of the energy-efficient refrigerant characteristics of 1,1-difluoroethane. This nonflammable high-energy-efficiency refrigerant blend of 1,1-difluroethane and trifluoroiodomethane has been reviewed and approved by the U.S. EPA.

In many applications, carbon dioxide has been used as a total flooding fire protection agent. Carbon dioxide is readily available, relatively inexpensive, stable, compatible, and has zero ODP and very low GWP. Carbon dioxide can prevent and extinguish fires at about 29 volume percent or higher concentration in air. However, the level of carbon dioxide lethal to humans for even short exposure periods is about 27 volume percent in air. As such, carbon dioxide is approved for use as a total flooding fire protection agent only in normally unoccupied areas. Despite precautions, however, there have been several human deaths in enclosed areas caused by carbon dioxide total flooding fire protection systems that have released their charge either by accident or because of a small fire or thermal event.

Certain highly fluorinated hydrofluorocarbons (HFCs) are also useful as combustion suppressants, because they have the advantages of zero ODP, good stability and compatibility, relatively low toxicity, moderate price, and reasonable effectiveness. However, although pentafluoroethane and 2H-heptafluoropropane are sold for total-flooding combustion suppression, they are disadvantageously characterized by greatly reduced performance compared to Halon 1301 (requiring much larger weights and volumes), higher prices relative to halons when in production, and have moderately high GWPs. They require larger systems than Halon 1301 and cannot be used in existing Halon 1301 fire protection systems. Such HFCs further tend to produce large quantities of the highly toxic and corrosive hydrogen fluoride gas during fire suppression operations.

While some or all of the above-referenced inventions may well be utilized for combustion suppression, they fail to adequately protect the environment and personnel who might suffer exposure.

Accordingly, there remains a continuing need for new combustion suppression compositions that have high effectiveness and reduced cost, combined with stability, compatibility, low toxicity, and low atmospheric impact, for implementation in fire protection applications and in rendering blends with other flammable components nonflammable.

### BRIEF SUMMARY OF THE INVENTION

Briefly described, in a preferred embodiment, the present invention overcomes the above-mentioned disadvantages and meets the recognized need for such combustion suppressant compositions and method of their use that is effective in combination with physical combustion suppressing agents, wherein the compositions are utilized to reduce the quantity of physical combustion suppressing agent required to render flammable materials non-flammable.

The present invention preferably comprises a chemical combustion suppressant of trifluoroiodomethane, preferably combined in a blend with a physical combustion suppression agent, such as, for exemplary purposes only, carbon dioxide, pentafluoroethane and/or 2H-heptafluoropropane.

A feature and advantage of the present invention is its suitability as a combustion suppressant composition.

A feature and advantage of the present invention is its compatibility with most common materials.

A feature and advantage of the present invention is its suitability for mixing with flammable components to yield useful nonflammable blends.

A feature and advantage of the present invention is that it produces less hydrogen fluoride gas than HFC agents when exposed to fire.

A feature and advantage of the present invention is its reduced toxicity.

A feature and advantage of the present invention is the miscibility of its components in the liquid phase.

A feature and advantage of the present invention is that it causes no stratospheric ozone depletion.

A feature and advantage of the present invention is that it has very low global warming potential.

A feature and advantage of the present invention is its synergistic combustion suppression via combination of particular physically-acting inertants with trifluoroiodomethane.

A feature and advantage of the present invention is its relatively low cost.

A feature and advantage of the present invention is its enhanced safety over existing products.

These and other features and advantages of the present invention will become more apparent to one skilled in the art from the following description and claims.

### BRIEF DESCRIPTION OF THE DRAWINGS

Having thus described the invention in general terms, the present invention will be better understood by reading the Detailed Description of the Preferred and Selected Alternate Embodiments with reference to the accompanying drawing figures, in which:

FIG. 1 is a diagram of Extinguishment Concentration vs. Composition of Blends of Trifluoroiodomethane and Physical Agents Showing synergism.

### DETAILED DESCRIPTION OF THE PREFERRED AND SELECTED ALTERNATIVE EMBODIMENTS

In describing the preferred and selected alternate embodiments of the present invention, specific terminology is employed for the sake of clarity. The invention, however, is not intended to be limited to the specific terminology so selected, and it is to be understood that each specific element includes all technical equivalents that operate in a similar manner to accomplish similar functions.

An attractive combustion suppressant should possess all of the following desirable properties: zero ODP, highly effective combustion suppression, low cost, stability, attractive physical properties, compatibility with most common materials, low toxicity, miscibility of the components in the liquid phase and with common flammable compounds, low generation of toxic by-products during fire suppression, and low global warming potential (GWP).

The novelty of this invention lies in identifying compositions that meet all of the above-cited criteria, and in particular exhibit cost-effective, reduced toxicity combustion suppression by synergistic interaction of particular combinations of trifluoroiodomethane with physically-acting suppressants.

Combustion suppression agents can be broadly classified as chemically-acting or physically-acting. Chemically-acting agents inhibit combustion by providing chemical species that remove radicals from the combustion zone. Trifluoroiodomethane is such a chemically-acting agent. Physically-acting agents inhibit combustion by removing heat energy from the combustion zone, absorbing the energy in internal molecular motion. Carbon dioxide and hydrofluorocarbons are primarily physically-acting agents. When small amounts of chemically-acting combustion suppressants are added to physically-acting combustion suppressants, synergistic combustion suppression was observed in some cases by the inventors of the compositions described herein. Synergistic combustion suppression is the combination of two suppressants wherein the resulting combination is more effective than would be expected by linear combination alone.

The present invention preferably comprises a combustion suppressant of trifluoroiodomethane preferably combined in a blend with a physical combustion suppression agent, such as, for exemplary purposes only, carbon dioxide, pentafluoroethane and/or 2H-heptafluoropropane. As such, here trifluoroiodomethane is blended with carbon dioxide, trifluoroiodomethane preferably comprising between approximately 0.5 percent molar fraction to approximately 75 percent molar fraction and carbon dioxide comprises a molar fraction of preferably between approximately 25 percent to approximately 99.5 percent. Where trifluoroiodomethane is blended with pentafluoroethane, trifluoroiodomethane preferably comprises from approximately between 1 percent molar fraction to approximately 75 percent molar fraction, and pentafluoroethane comprises a molar fraction of preferably between approximately 25 percent to approximately 99 percent. Where trifluoroiodomethane is blended with 2H-heptafluoropropane, trifluoroiodomethane preferably comprises from approximately between 5 percent molar fraction to approximately 85 percent molar fraction, and 2H-heptafluoropropane comprises a molar fraction of preferably between approximately 15 percent to approximately 95 percent.

The above-described combustion suppressant agent blends are preferably utilized to render flammable compounds non-flammable, wherein such flammable compounds may include, but are not limited to, hydrogen, hydrocarbons, alcohols, such as, for exemplary purposes only, methanol, and ethers, hydrofluorocarbons, hydrochlorocarbons and ketones, such as, for exemplary purposes only, acetone.

Preferably, the combustion suppressant agent blends include additives, preferably in the form of propelling agents, in order to facilitate dispensing of the combustion suppressant agent. Such propelling agents preferably include hydrofluorocarbons, such as, for exemplary purposes only, trifluoromethane, 1,1,1,2-tetrafluoroethane, and 1,1,1,3,3-pentafluoropropane, and hydrofluoroethers, hydrochlorocarbons and perfluorocarbons.

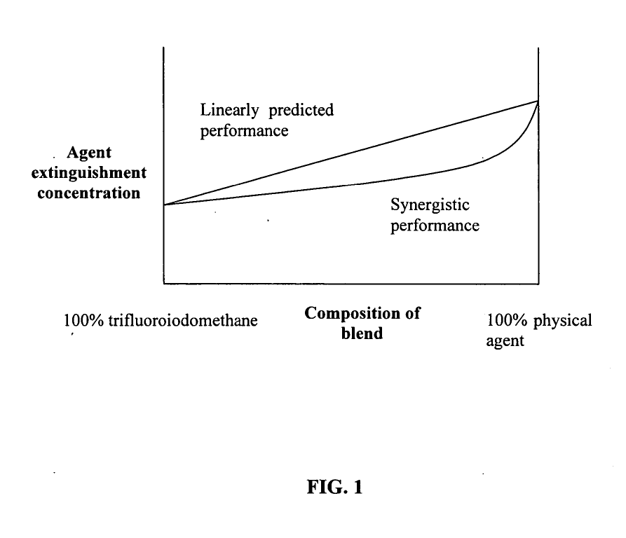

The present inventors have tested hundreds of blends of trifluoroiodomethane with physically-acting suppressants and various fuels. The present inventors previously considered combinations of trifluoroiodomethane with either pentafluoroethane and heptafluoropropane, but there was no indication of synergism based on available data. Moreover, in a 1995 report, Tapscott et al. had considered blends of trifluoroiodomethane with pentafluoroethane or heptafluoropropane, but did not state that they found synergy, nor did they consider these to be attractive combustion suppressant blends, sufficient to warrant further study. Additionally, the present inventors reran some of the tests reported in this publication and found the published data to be seriously in error. Although most combinations show no synergism, the present inventors unexpectedly found that the combination of trifluoroiodomethane with carbon dioxide, pentafluoroethane, or 2H-heptafluoropropane provides an unanticipated, large, synergistic combustion suppression that could not have been predicted. FIG. 1 illustrates the behavior of these blends, wherein a small amount of trifluoroiodomethane added to the physically-acting combustion suppressant results in a large decrease in the concentration of the blend needed to suppress flammability (i.e., a large increase in effectiveness).

Trifluoroiodomethane, carbon dioxide, pentafluoroethane, and/or 2H-heptafluoropropane are miscible in liquid form. Because the physically-acting suppressants are less expensive than trifluoroiodomethane, and the effectiveness thereof enhanced, the resulting combustion suppressant compositions are accordingly reduced in cost. Additionally, because the components are thermally stable and do not chemically interact with one another, the resulting combustion suppressant formulations are stable. Moreover, due to the compatibility of the components with most common materials, the resulting combustion suppressants are accordingly compatible with most common materials. Furthermore, as a result of less suppressant being utilized, the toxicity of the resulting blend in application is advantageously greatly reduced.

### Industrial Applicability

Application of the present compositions is further illustrated by the following non-limiting examples. The following examples show the effectiveness of the compositions as low-cost, stable, compatible, zero ODP, very low GWP, reduced toxicity combustion suppressants.

### EXAMPLE 1

In a computer room a total flooding fire protection system is installed, wherein the system contains a blend of carbon dioxide and trifluoroiodomethane. The combustion suppression effectiveness of the blend by volume is approximately 2.5 times greater than carbon dioxide alone. A release of the combustion suppressant in the room provides effective fire protection and results in only about 12 volume percent carbon dioxide in the room air. The 12 volume percent concentration is well below carbon dioxide's lethal concentration of 27 volume percent, and is thus much safer than pure carbon dioxide suppressant. Additionally, the concentration of trifluoroiodomethane is much lower than if pure trifluoroiodomethane was utilized. The blend is much less expensive than pure 2H-heptafluoropropane or trifluoroiodomethane, and requires much smaller tanks and plumbing than pure carbon dioxide. As a result of this procedure, the equipment in the room has been protected from fire, cost has been reduced compared to pure 2H-heptafluoropropane or trifluoroiodomethane, toxicity risk and system size (and cost) has been reduced compared to pure carbon dioxide, and minimal atmospheric impact has been caused.

### EXAMPLE 2

On board a ship, total flooding fire protection systems utilizing a blend of carbon dioxide and trifluoroiodomethane have been installed in critical areas. The blend of carbon dioxide and trifluoroiodomethane being utilized is about three times more effective per volume percent than carbon dioxide alone. A release of the combustion suppressant provides effective fire protection and results in only about nine volume percent carbon dioxide in the room air. The nine volume percent concentration is about one-third of carbon dioxide's lethal concentration of 27 volume percent, and is thus much safer than pure carbon dioxide suppressant. The resulting concentration of trifluoroiodomethane is much lower than its effective combustion suppression concentration of three volume percent and is thus much safer than pure trifluoroiodomethane. The blend is much less expensive than pure 2H-heptafluoropropane or trifluoroiodomethane, and requires much smaller tanks and plumbing than pure carbon dioxide. As a result of this procedure, critical equipment in the ship has been protected from fire, cost has been reduced compared to pure 2H-heptafluoropropane or trifluoroiodomethane, toxicity risk and system size (and cost) has been reduced compared to pure carbon dioxide, and minimal atmospheric impact has been caused.

### EXAMPLE 3

A nonflammable, moderate pressure extraction solvent formulated using 1,1-difluoroethane, pentafluoroethane, and trifluoroiodomethane is utilized to extract natural products from dried seaweed. The extraction solvent blend has good characteristics for solvating certain compounds because of its 1,1-difluoroethane and trifluoroiodomethane content. The seaweed is extracted by the solvent blend under pressure at room temperature or slightly warmer. The solvent blend containing the extracted materials is then pumped into another chamber where pressure is released and the components of the solvent evaporated, leaving the extracted material behind. The evaporated solvent components are re-condensed and utilized for the next extraction. The extraction solvent blend has increased safety because it is nonflammable. Additionally, because the extraction solvent can be evaporated from the extracted materials at low temperature, sensitive compounds are not damaged by heat. Moreover, because of the synergistic combustion suppression of pentafluoroethane with trifluoroiodomethane, the cost of the two combustion suppressants in the solvent blend is minimized. All of the components of the solvent blend are stable and compatible with common materials of extraction equipment construction. As a result of this procedure, high quality natural product extracts have been isolated, no flammability risk has been incurred, and cost has been reduced compared to utilization of other combustion suppression agents.

### EXAMPLE 4

At or near a postal or package facility, mail and packages are placed into a sterilization chamber. Most of the air is evacuated and into the chamber is introduced a blend of ethylene oxide (EtO) with synergistic combustion suppressants carbon dioxide and trifluoroiodomethane. The mail and packages are exposed to the gas for a period of time sufficient to kill hazardous microorganisms. The gas is then evacuated from the chamber through a scrubber or catalytic oxidizer and the chamber is purged with air to remove residual EtO. As a result of this procedure the mail and packages are rendered free of pathogenic organisms.

### EXAMPLE 5

Halon 1301 is removed from the fuel tank inerting system on a military aircraft, is replaced with a blend of trifluoroiodomethane and 2H-heptafluoropropane having essentially equivalent effectiveness. As a result of this change, the fuel tanks are protected at reduced cost, there is no need to change delivery systems, the inertant is commercially available and does not draw down stockpiles of Halon 1301, ozone depletion has been eliminated, and global warming has been reduced.

### EXAMPLE 6

A building, passenger cruise liner, or other enclosed area has been the site of contamination with a contagious bacterium or virus and must be decontaminated. After opening internal doorways and closing openings to the outside (e.g. closing external windows and sealing exterior doorways), a nonflammable blend of ethylene oxide (EtO) containing the synergistic combustion suppressants carbon dioxide and trifluoroiodomethane is pumped into the area at the lowest levels, while air is displaced from the highest levels through a scrubber or catalytic oxidizer that destroys any escaping EtO. The interior area is sealed and the gas is allowed to remain inside for one to several days. Meanwhile the concentration of EtO is monitored and more of the nonflammable gas blend is added as needed to maintain a level of approximately 200 to 300 mg/L ethylene oxide. At the end of the sterilization time, air is circulated through the interior area and a scrubber or catalytic oxidizer until residual EtO concentration is below 1 ppm. The area is then unsealed and can be safely returned to service. Through use of this procedure no flammability risk was incurred, the pathogenic agents were destroyed even in hidden areas, the area was returned to service quickly, no personnel were exposed to toxic disinfectants, and minimal atmospheric impact occurred.

### EXAMPLE 7

A nonflammable, supercritical solvent blend of carbon dioxide, trifluoroiodomethane, and methanol is utilized as a medium for a synthetic chemical reaction. The supercritical solvent effectively dissolves the reactants and catalyst for increased reaction rate and higher yield. As a result, the cost of the product is reduced, atmospheric impact is minimized, flammability risk is eliminated, and waste products are reduced.

### EXAMPLE 8

A polyurethane foam is blown with a nonflammable blend of trifluoroiodomethane, isobutane, and 2H-heptafluoropropane. As a result, the flammability risk from the blowing agent is eliminated. The foam produced has superior insulating and aging properties and reduced flammability compared to foams blown with hydrocarbons alone.

### EXAMPLE 9

The chlorodifluoromethane (R-22, hydrochlorofluorocarbon-22) refrigerant is removed from an air conditioner, and replaced with a nonflammable blend of 1,1-difluoroethane, trifluoroiodomethane, and pentafluoroethane. Because of synergistic combustion suppression, a high percentage of the energy-efficient, but flammable refrigerant 1,1-difluoroethane, can be in the blend. By using this refrigerant in place of R-22, there is no danger of ozone depletion in case of leakage, and the system pressure and compressor temperature are reduced, thereby increasing compressor lifetime.

The preceding examples can be repeated with similar success by substituting the generically or specifically described reactants and/or operating conditions of this invention for those utilized in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents.

The foregoing description and drawings comprise illustrative preferred and alternate embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not necessarily constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A combustion suppressant composition comprising trifluoroiodomethane and a physical combustion suppression agent comprising carbon dioxide, wherein said suppressant composition is synergistic.

2. The combustion suppressant compositions of claim 1 comprising from about 0.5% by volume to about 75% by volume trifluoroiodomethane and from about 25% to about 99.5% by volume of carbon dioxide.

3. The combustion suppressant compositions of claim 5 comprising from about 1% by volume to about 75% by volume trifluoroiodomethane and from about 25% to about 99% by volume of pentafluoroethane.

4. The combustion suppressant compositions of claim 5 comprising from about 5% by volume to about 85% by volume trifluoroiodomethane and from about 15% to about 95% by volume of 2H-heptafluoropropane.

5. A composition comprising at least one flammable compound and at least one suppressant blend, wherein said at least one suppressant blend comprises trifluoroiodomethane and at least one physical combustion suppression agent selected from the group consisting of pentafluoroethane, and 2H-heptafluoropropane, and wherein said composition is synergistic.

6. The composition of claim 5, wherein said at least one flammable compound comprises at least one component selected from the group consisting of hydrogen, hydrocarbons, alcohols, ethers, hydrofluorocarbons, hydrochlorocarbons, and ketones.

7. The composition of claim 6, wherein said at least one flammable compound comprises a ketone, and wherein said ketone comprises acetone.

8. The composition of claim 6, wherein said at least one flammable compound comprises an alcohol, and wherein said alcohol comprises methanol.

9. The composition of claim 5, wherein said at least one suppressant blend further comprises an additive selected from the group consisting of trifluoromethane, 1,1,1,2-tetrafluoroethane, 1,1,1,3,3-pentafluoropropane, hydrofluoroethers, hydrochlorocarbons, and perfluorocarbons.

10. A method of making a combustion suppression composition comprising the step of:
a) blending trifluoroiodomethane and at least one physical combustion suppression agent selected from group consisting of pentafluoroethane, and 2H-heptafluoropropane, wherein said composition is synergistic.

11. The method of making a combustion suppression composition of claim 10 further comprising the step of:
b) adding at least one additive.

12. The method of making a combustion suppression composition of claim 11, wherein said additive is selected from the group consisting of trifluoromethane, 1,1,1,2-tetrafluoroethane, and 1,1,1,3,3-pentafluoropropane.

13. A method of suppressing combustion of flammable compounds comprising the step of:
a) combining at least one flammable compound and at least one combustion suppression combination, wherein said at least one combustion suppression combination comprises trifluoroiodomethane and a physically-acting combustion suppressant comprising carbon dioxide, and wherein said combination is synergistic.

14. The method of claim 13, wherein said at least one flammable compound comprises at least one compound selected from the group consisting of hydrogen, hydrocarbons, alcohols, ethers, hydrofluorocarbons, hydrochlorocarbons, and ketones.

15. The method of claim 14, wherein said at least one flammable compound comprises an alcohol, and wherein said alcohol comprises methanol.

16. The method of claim 13, further comprising the step of:
b) adding at least one additive.

17. The method of claim 16, wherein said at least one additive is selected from the group consisting of hydrofluorocarbons, hydrofluoroethers, hydrochlorocarbons, and perfluorocarbons.

18. The method of claim 17, wherein said hydrofluorocarbon is selected from the group consisting of trifluoromethane, 1,1,1,2-tetrafluoroethane, and 1,1,1,3,3-pentafluoropropane.

19. A supercritical solvent comprising carbon dioxide, trifluoroiodomethane and an alcohol.

20. The supercritical solvent of claim 19, wherein said alcohol is methanol.
